(19) United States
(12) Patent Application Publication
(10) Pub. No.: US 2014/0225864 A1
(43) Pub. Date: Aug. 14, 2014

(54) TOUCH PANEL AND MANUFACTURING METHOD THEREOF

(71) Applicant: WINTEK CORPORATION, Taichung City (TW)

(72) Inventors: Ting-Yu Chang, Kaohsiung City (TW); Kuo-Chang Su, Taichung City (TW); Siang-Lin Huang, Taichung City (TW); Yen-Chung Hung, Taichung City (TW)

(73) Assignee: WINTEK CORPORATION, Taichung City (TW)

(21) Appl. No.: 14/174,862

(22) Filed: Feb. 7, 2014

(30) Foreign Application Priority Data
Feb. 8, 2013 (TW) 102105305

(51) Int. Cl. G06F 3/044; G02F 1/1333

(52) U.S. Cl. CPC G06F 3/044; G02F 1/13338
USPC 345/174

(57) ABSTRACT

A touch panel includes a substrate, a plurality of first sensing units arranged on the substrate along a first direction, a plurality of second sensing units arranged on the substrate along a second direction different from the first direction; a plurality of first bridge units for electrically connecting two adjacent first sensing units, a plurality of second bridge units arranged across over the plurality of first bridge units for electrically connecting two adjacent second sensing units, and a plurality of insulation units respectively arranged between the corresponding first bridge units and the second bridge units, wherein the plurality of first sensing units and the plurality of second sensing units are formed by performing same lithography and etching steps on a first conductive layer and a second conductive layer after the second conductive layer forming on the first conductive layer.

### BACKGROUND OF THE INVENTION

1. Field of the Invention

The present invention relates to a touch panel and a manufacturing method thereof, in particular, to a touch panel having a double conductive layer structure and a manufacturing method thereof.

2. Description of the Prior Art

A capacitive touch panel generally comprises a plurality of first sensing units arranged along a first direction (such as a horizontal direction), and a plurality of second sensing units arranged along a second direction (such as a vertical direction). A driver of the capacitive touch panel can output driving signals to the first sensing units, and receive corresponding sensing signals generated by the second sensing units. Thereafter, the capacitive touch panel correspondingly generates touch position signals according to received sensing signals. Generally, the first sensing units and the second sensing units of the capacitive touch panel are made of transparent conductive material. However, resistance of the transparent conductive material may affect response time and signal integrality of the capacitive touch panel. In addition, if the sensing units are made of non-transparent conductive material (such as metal grids), and wire width of the metal grid is too small, there is also a problem of high resistance. Therefore, it is a very important topic to reduce resistance of the first sensing units and the second sensing units for the capacitive touch panel.

### SUMMARY OF THE INVENTION

According to one embodiment of the present invention, a touch panel of the present invention comprises a substrate; a plurality of first sensing units, arranged on the substrate along a first direction; a plurality of second sensing units, arranged on the substrate along a second direction different from the first direction; a plurality of first bridge units, for electrically connecting two adjacent first sensing units; a plurality of second bridge units, arranged across over the plurality of first bridge units for electrically connecting two adjacent second sensing units; and a plurality of insulation units, respectively arranged between the corresponding first bridge units and the second bridge units; wherein the plurality of first sensing units and the plurality of second sensing units are formed by performing same lithography and etching stepson a first conductive layer and a second conductive layer after the second conductive layer forming on the first conductive layer.

According to another embodiment of the present invention, a touch panel of the present invention comprises a substrate; a plurality of first sensing units, arranged on the substrate along a first direction; a plurality of second sensing units, arranged on the substrate along a second direction different from the first direction; a plurality of first bridge units, for electrically connecting two adjacent first sensing units; a plurality of second bridge units, arranged across over the corresponding first sensing units for electrically connecting two adjacent second sensing units; and a plurality of insulation units, respectively arranged between the corresponding first sensing units and the second bridge units; wherein the plurality of first sensing units and the plurality of second sensing units are formed from a first conductive layer and a second conductive layer disposed on the first conductive layer.

According to another embodiment of the present invention, a touch panel of the present invention comprises a substrate; a plurality of first sensing units, arranged on the substrate along a first direction; a plurality of second sensing units, arranged on the substrate along a second direction different from the first direction; a plurality of first bridge units, arranged between two adjacent first sensing units; a plurality of second bridge units, arranged across over the plurality of first bridge units for electrically connecting two adjacent second sensing units; a plurality of first connection units, for electrically connecting the first sensing units and the first bridge units; and a plurality of insulation units, respectively arranged between the corresponding first bridge units and the second bridge units; wherein the plurality of first sensing units and the plurality of second sensing units are formed from two conductive layers.

In contrast to the prior art, the touch panel of the present invention has a double conductive layer structure for reducing resistance of the first sensing units and the second sensing units. Therefore, the touch panel of the present invention can have shorter response time and better signal integrality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a manufacturing method of a touch panel according to a first embodiment of the present invention.

FIG. 2 is a schematic diagram illustrating the manufacturing method of the touch panel according to the first embodiment of the present invention.

FIG. 3 is a cross-sectional view of the touch panel according to the first embodiment of the present invention.

FIG. 4 is a schematic diagram illustrating a manufacturing method of a touch panel according to a second embodiment of the present invention.

FIG. 5 is a schematic diagram illustrating the manufacturing method of the touch panel according to the second embodiment of the present invention.

FIG. 6 is a cross-sectional view of the touch panel according to the second embodiment of the present invention.

FIG. 7 is a schematic diagram illustrating a manufacturing method of a touch panel according to a third embodiment of the present invention.

FIG. 8 is a schematic diagram illustrating the manufacturing method of the touch panel according to the third embodiment of the present invention.

FIG. 9 is a cross-sectional view of the touch panel according to the third embodiment of the present invention.

FIG. 10 is a schematic diagram illustrating a manufacturing method of a touch panel according to a fourth embodiment of the present invention.

FIG. 11 is a schematic diagram illustrating the manufacturing method of the touch panel according to the fourth embodiment of the present invention.

FIG. 12 is a cross-sectional view of the touch panel according to the fourth embodiment of the present invention.

FIG. 13 is a schematic diagram illustrating a manufacturing method of a touch panel according to a fifth embodiment of the present invention.

FIG. 14 is a schematic diagram illustrating the manufacturing method of the touch panel according to the fifth embodiment of the present invention.

FIG. 15 is a cross-sectional view of the touch panel according to the fifth embodiment of the present invention.

### DETAILED DESCRIPTION

For convenience of explanation, in figures of the present invention, only two first sensing units and two second sensing units are shown to represent a touch panel. The touch panel of the present invention can comprise a sensing matrix having more first sensing units and second sensing units. Therefore, a signal element shown in the figures can be plural in the touch panel of the present invention.

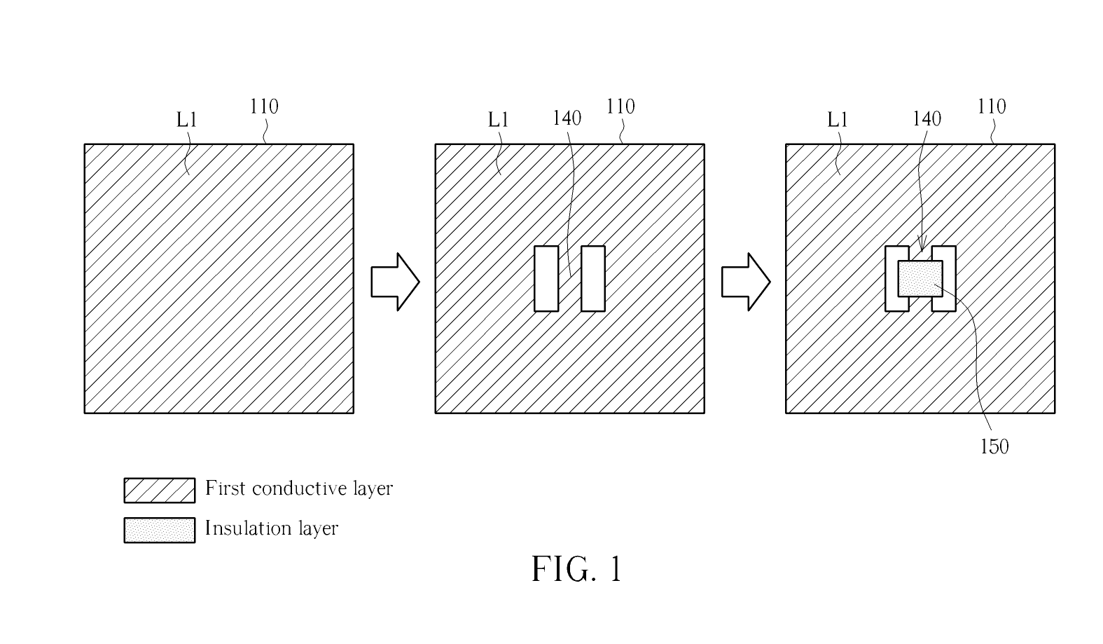

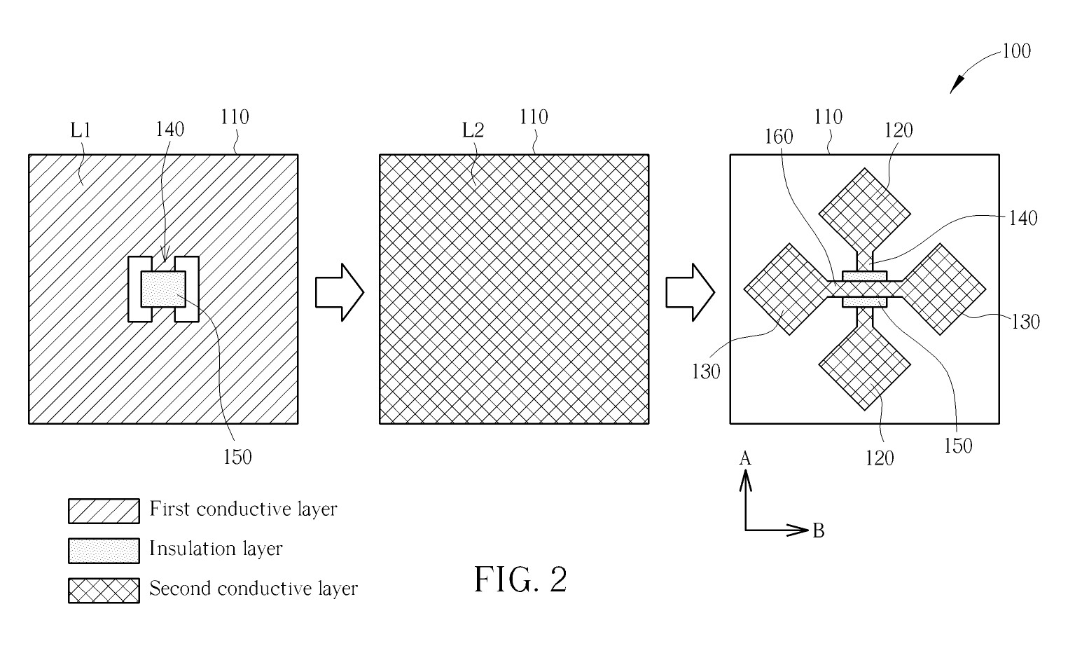

Please refer to FIG. 1 and FIG. 2 together. FIG. 1 and FIG. 2 are diagrams illustrating a manufacturing method of a touch panel 100 according to a first embodiment of the present invention. As shown in figures, a first conductive layer L1 is first formed on a substrate 110. After performing lithography and etching steps on the first conductive layer L1, a first bridge unit 140 is formed. Thereafter, an insulation unit 150 is formed above the first bridge unit 140 (for example, an insulation layer can be deposited on the first conductive layer, and then etched to form the insulation unit 150). After forming the insulation unit 150, a second conductive layer L2 is formed to cover all elements. other lithography and etching steps are then performed on the first conductive layer L1 and the second conductive layer L2 simultaneously for forming first sensing units 120 arranged along a first direction A, second sensing units 130 arranged along a second direction B different from the first direction and a second bridge unit 160.

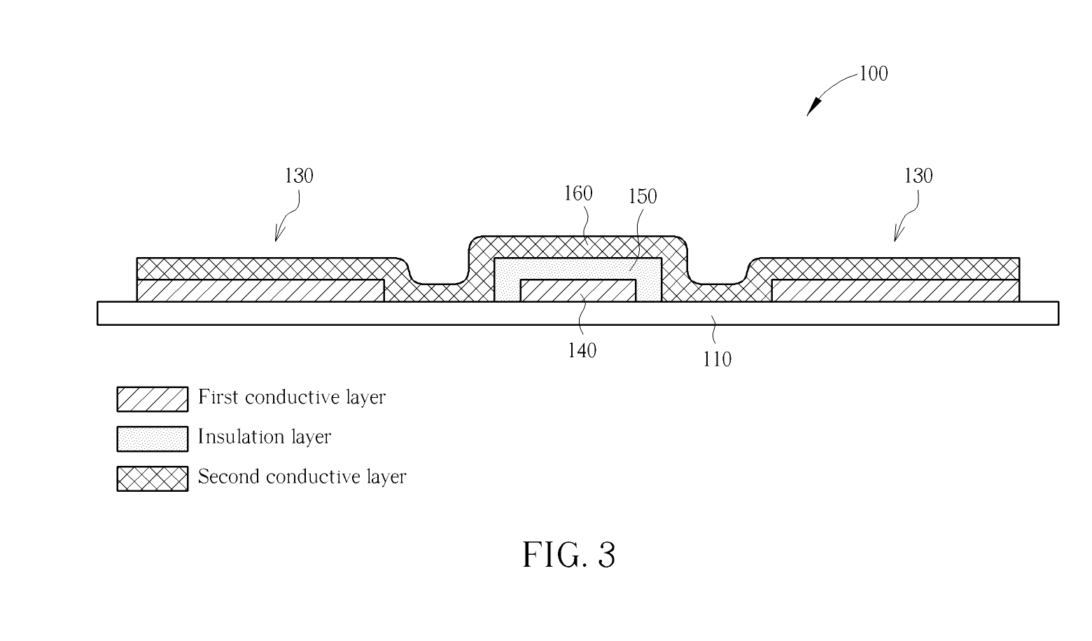

Please refer to FIG. 3, and refer to FIG. 1 and FIG. 2 as well. FIG. 3 is a cross-sectional view of the touch panel 100 according to the first embodiment of the present invention. As shown in figures, the first bridge unit 140 is for electrically connecting two adjacent first sensing units 120. The second bridge unit 160 is for electrically connecting two adjacent second sensing units 130, and the second bridge unit 160 is arranged across over the first bridge unit 140. The insulation unit 150 is arranged between the first bridge unit 140 and the second bridge unit 160 for insulating the first bridge unit 140 and the second bridge unit 160. The first bridge unit 140 is formed from the first conductive layer. The second bridge unit 160 is formed from the second conductive layer. Portions at two ends of the first bridge unit 140 not covered by the insulation unit 150 can be optionally stacked with the second conductive layer, in order to further reduce resistance of the first bridge unit 140, which is narrow relative to the first sensing units 120. On the other hand, the first bridge unit 140 is not limited to the above embodiment, in other embodiments, after the lithography and etching step is performed on the first conductive layer L1 to form the first bridge unit 140, the first bridge unit 140 can be formed as an isolated island without connecting to other areas of the first conductive layer. In other words, areas of the first conductive layer nearby and surrounding the first bridge unit 140 are etched, and the same following steps are performed later on.

According to the above arrangement, the first sensing units 120 and the second sensing units 130 are formed from two conductive layers, that is, cross-sectional areas of the first sensing units 120 and the second sensing units 130 are increased, such that resistance of the first sensing units 120 and the second sensing units 130 can be reduced. Since the first sensing units 120 and the second sensing units 130 are formed by performing the same lithography and etching steps, outlines of the upper conductive layers of the first sensing unit 120 and the second sensing unit 130 are substantially identical to outlines of the lower conductive layers of the first sensing unit 120 and the second sensing unit 130 without misalignment. In other words, the first sensing units 120 and the second sensing units 130 have the substantially same outline. Therefore, for the sensing unit having a complex outline (such as the sensing unit having a snowflake shaped or comb shaped outline with a plurality of concave parts and convex parts or other irregular outline), the present embodiment can form such sensing unit by performing the same lithography and etching steps on the first conductive layer and the second conductive layer, in order to reduce difficulty of the manufacturing process.

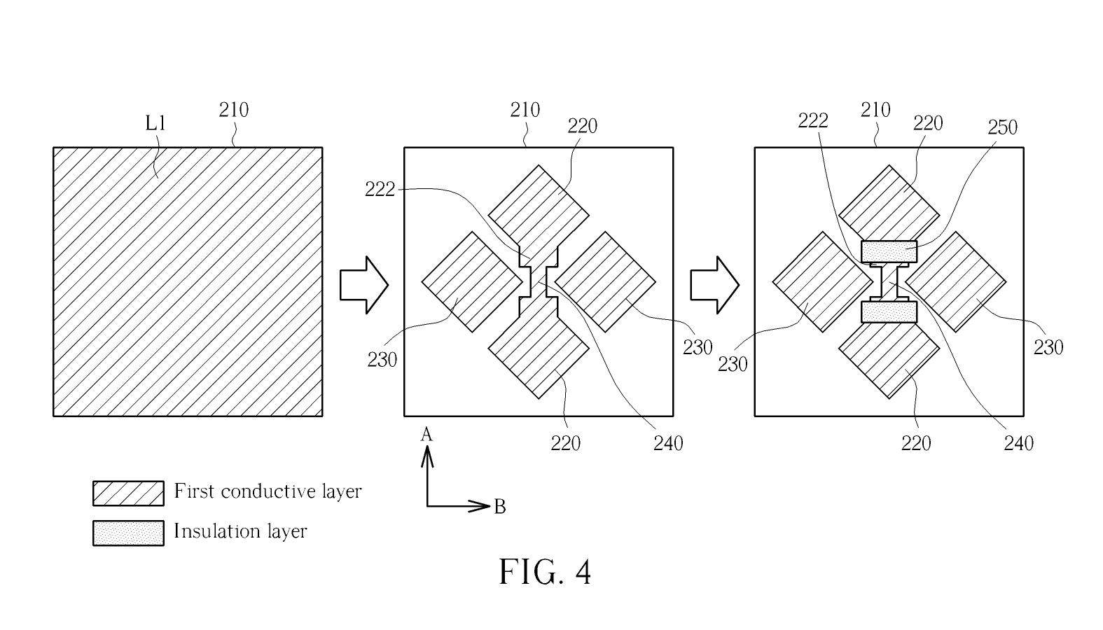

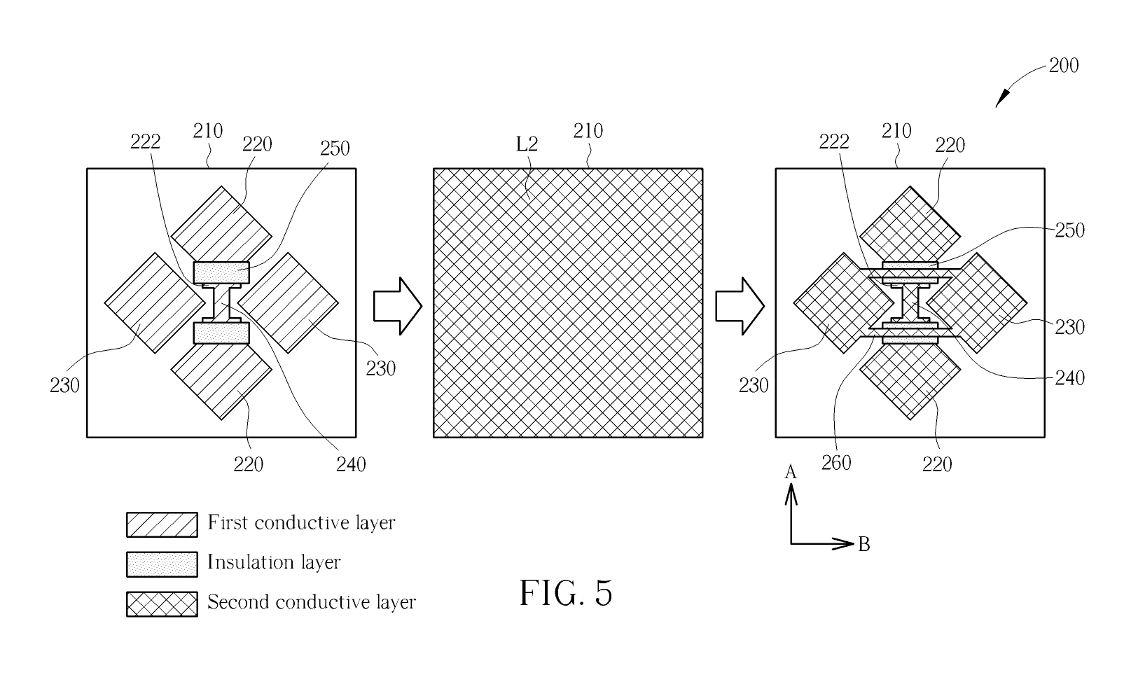

Please refer to FIG. 4 and FIG. 5 together. FIG. 4 and FIG. 5 are diagrams illustrating a manufacturing method of a touch panel 200 according to a second embodiment of the present invention. As shown in figures, a first conductive layer L1 is first formed on a substrate 210. After performing lithography and etching steps on the first conductive layer L1, a lower layer portion of the first sensing units 220 arranged along the first direction A, a lower layer portion of the second sensing units 230 arranged along the second direction B, and a first bridge unit 240 are formed. Thereafter, insulation units 250 are formed above the lower layer portion of the first sensing unit 220 (for example, an insulation layer can be deposited on the first conductive layer, and then etched to form the insulation units 250). After forming the insulation units 250, a second conductive layer L2 is formed to cover all elements. other lithography and etching steps are then performed on the second conductive layer L2 for forming an upper layer portion of the first sensing units 220, an upper layer portion of the second sensing units 230, and second bridge units 260.

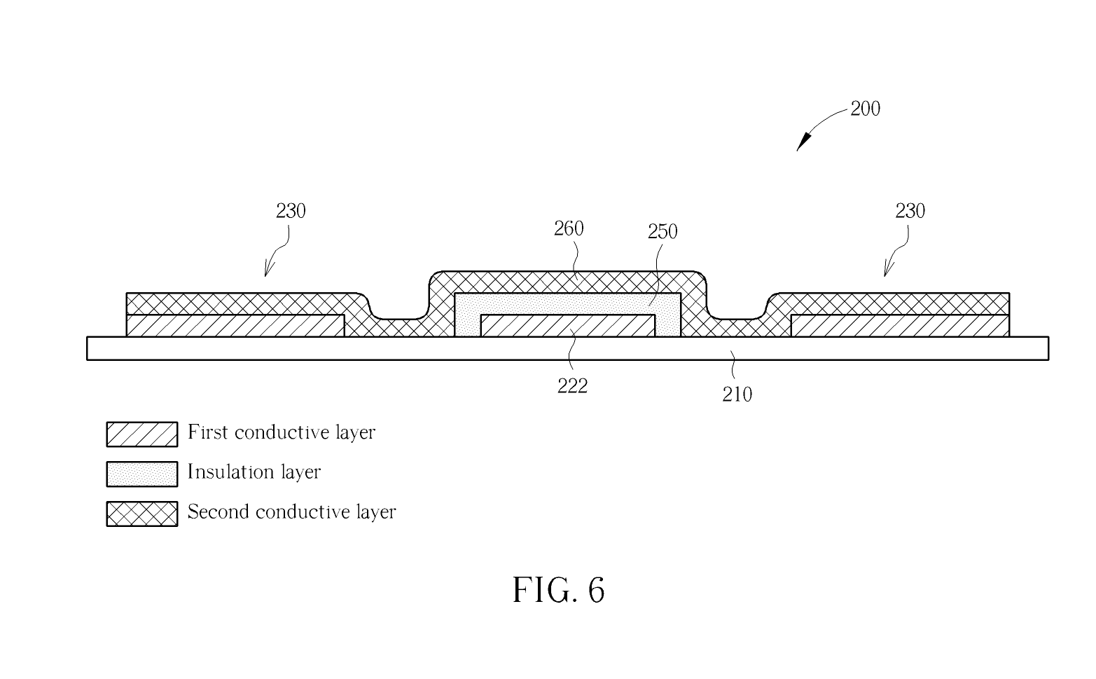

Please refer to FIG. 6, and refer to FIG. 4 and FIG. 5 as well. FIG. 6 is a cross-sectional view of the touch panel 200 according to the second embodiment of the present invention. As shown in figures, the first bridge unit 240 is for electrically connecting two adjacent first sensing units 220. The second bridge unit 260 is for electrically connecting two adjacent second sensing units 230, and the second bridge unit 260 is arranged across over an extension part 222 of the first sensing unit 220. The insulation units 250 are arranged between the first sensing units 220 and the second bridge units 260 for insulating the first sensing units 220 and the second bridge units 260. The first bridge unit 240 is formed from the first conductive layer. The second bridge unit 260 is formed from the second conductive layer.

Similarly, the first sensing units 220 and the second sensing units 230 are formed from two conductive layers, such that resistance of the first sensing units 220 and the second sensing units 230 can be reduced. In addition, the second conductive layer can be left on some part of the first bridge unit 240, in order to reduce resistance of the first bridge unit 240. The second conductive layer also can be removed from an upper surface of the first bridge unit 240. In the present embodiment, the first sensing unit 220 comprises an extension part 222 extended outward, for allowing the second bridge unit 260 to be arranged across over. But in other embodiment of the present invention, the extension part 222 is not necessary, in other words, the second bridge unit 260 can be arranged across over any other part of the first sensing unit.

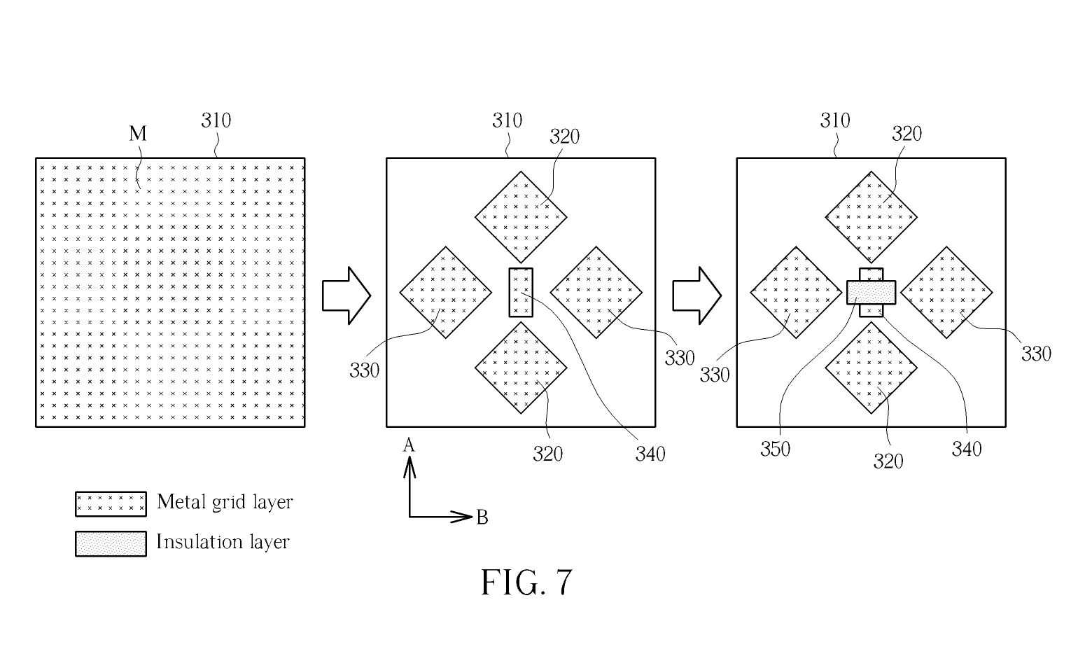

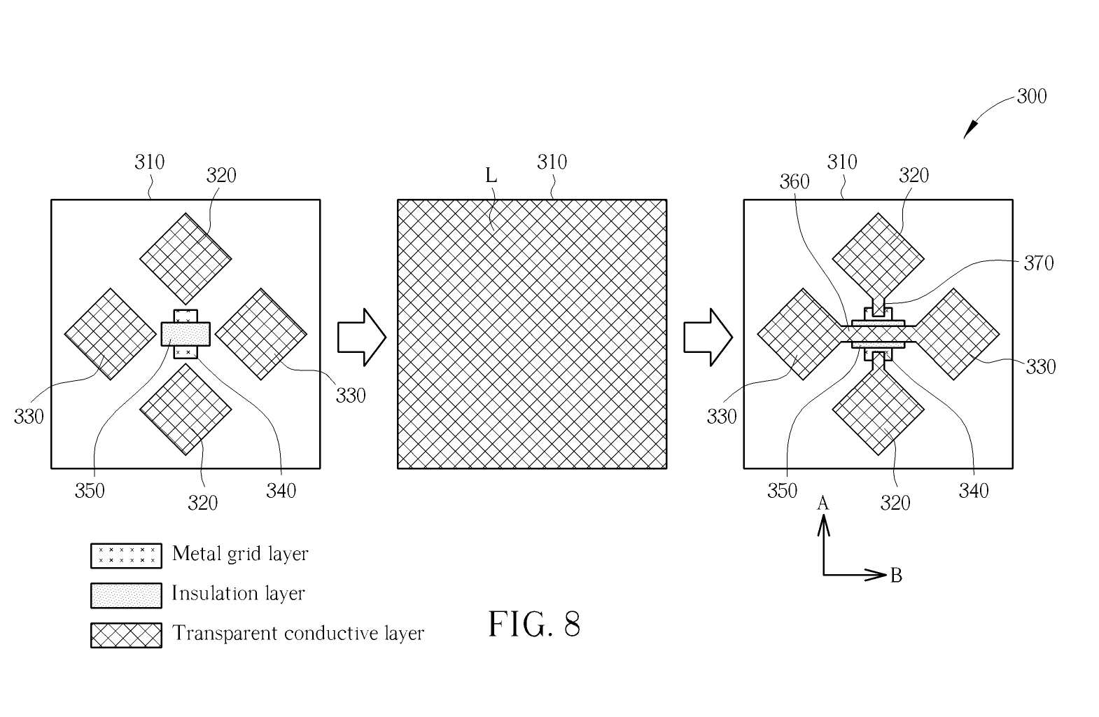

Please refer to FIG. 7 and FIG. 8 together. FIG. 7 and FIG. 8 are diagrams illustrating a manufacturing method of a touch panel 300 according to a third embodiment of the present invention. As shown in figures, a metal grid layer M is first formed on a substrate 310. After performing lithography and etching steps on the metal grid layer M, a lower layer portion of the first sensing units 320 arranged along the first direction A, a lower layer portion of the second sensing units 330 arranged along the second direction B, and a first bridge unit 340 are formed. Thereafter, an insulation unit 350 is formed above the first bridge unit 340 (for example, an insulation layer can be deposited on the metal grid layer, and then etched to form the insulation unit 350). After forming the insulation unit 350, a transparent conductive layer L is formed to cover all elements. other lithography and etching steps are then performed on the transparent conductive layer L for forming an upper layer portion of the first sensing units 320, an upper layer portion of the second sensing units 330, a second bridge unit 360, and first connection units 370.

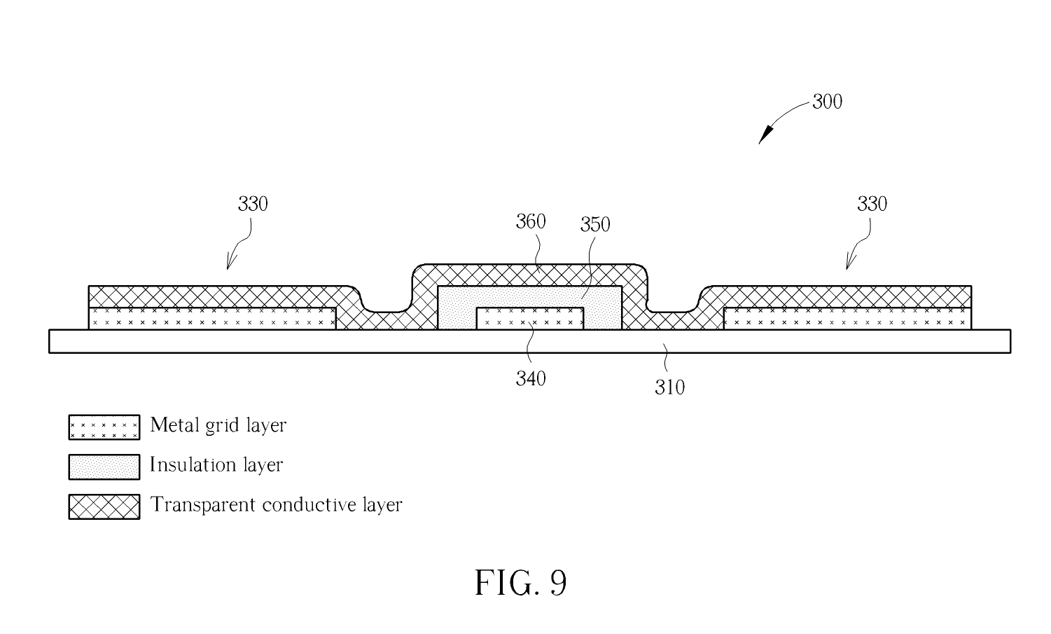

Please refer to FIG. 9, and refer to FIG. 7 and FIG. 8 as well. FIG. 9 is a cross-sectional view of the touch panel 300 according to the third embodiment of the present invention. As shown in figures, the first connection units 370 are for electrically connecting the first sensing units 320 and the first bridge unit 340, so as to electrically connect the two adjacent first sensing units 320. An end of the first connection unit 370 is disposed on the first bridge unit 340. The second bridge unit 360 is for electrically connecting two adjacent second sensing units 330, and the second bridge unit 360 is arranged across over the first bridge unit 340. The insulation unit 350 is arranged between the first bridge unit 340 and the second bridge unit 360 for insulating the first bridge unit 340 and the second bridge unit 360. The first bridge unit 340 is formed from the metal grid layer. The second bridge unit 360 and the first connection units 370 are formed from the transparent conductive layer.

According to the above embodiment, the first sensing units 320 and the second sensing units 330 are formed from two conductive layers (the metal grid layer and the transparent conductive layer), that is, cross-sectional areas of the first sensing units 320 and the second sensing units 330 are increased, such that resistance of the first sensing units 320 and the second sensing units 330 can be reduced. In addition, the metal grid layer can further reduce resistance of the first sensing units 320 and the second sensing units 330. The transparent conductive layer can be left on some part of the first bridge unit 340, in order to reduce resistance of the first bridge unit 340. The second conductive layer also can be removed from an upper surface of the first bridge unit 340. In other embodiment of the present invention, forming sequences of the metal grid layer M and the transparent conductive layer L can be interchanged, such that the transparent conductive layer L is located under the metal grid layer M, thus the first bridge unit is formed from the transparent conductive layer, and the second bridge unit is formed from the metal grid layer. On the other hand, in other embodiments of the present invention, the metal grid layer can be replaced by a metal thin layer without grid or a transparent conductive layer.

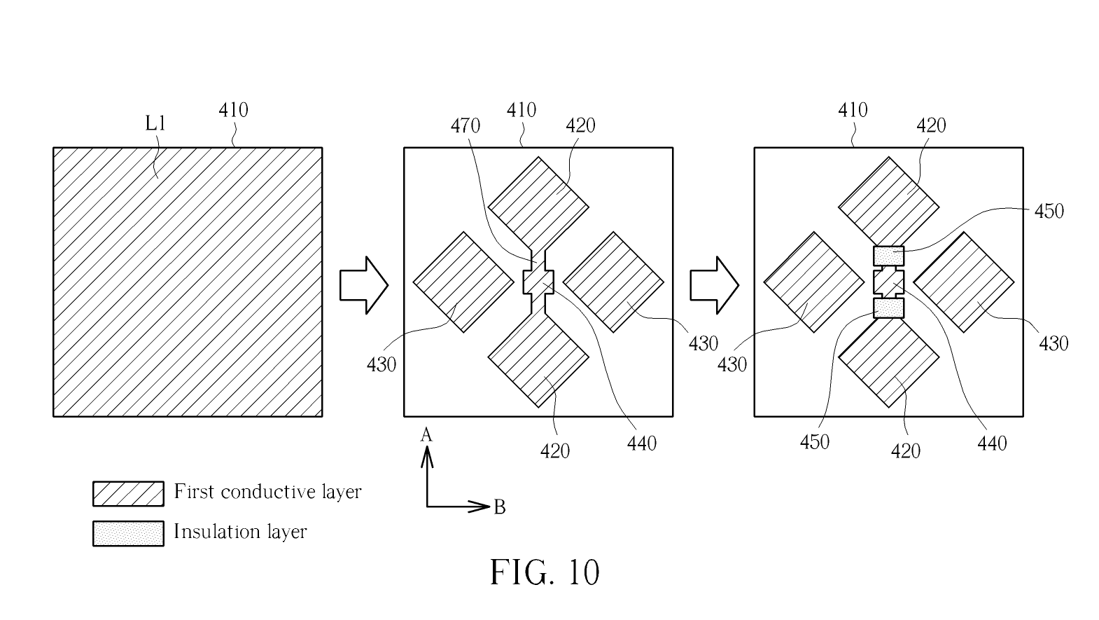

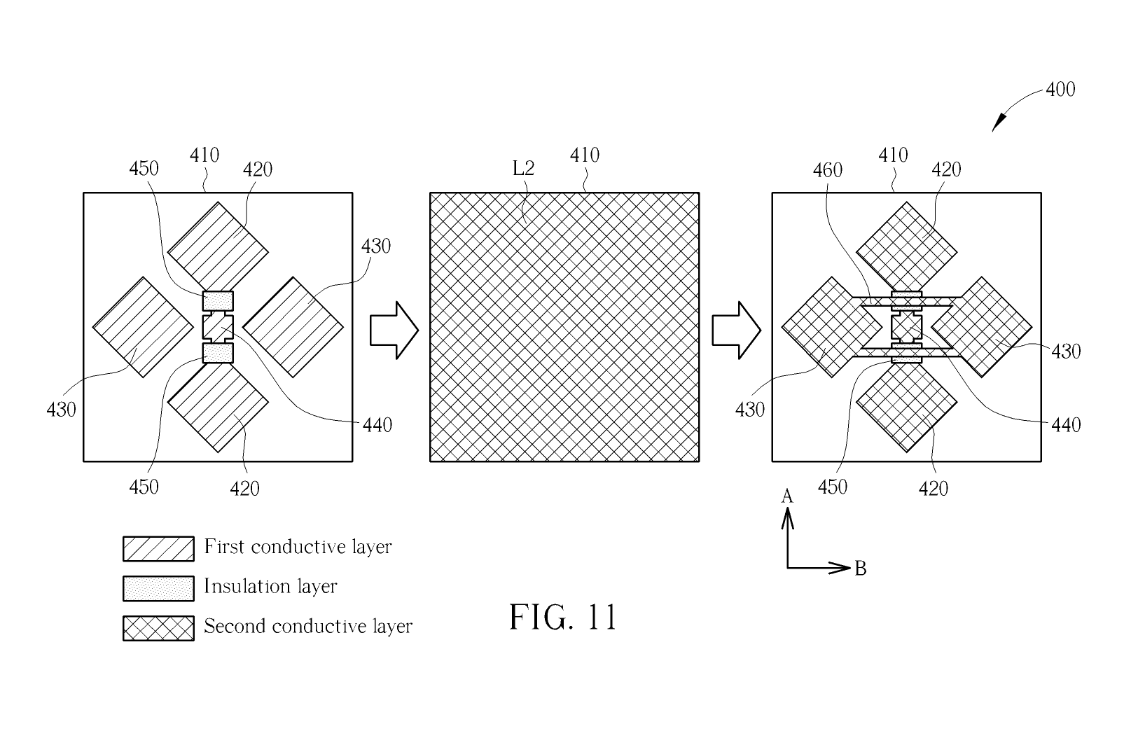

Please refer to FIG. 10 and FIG. 11 together. FIG. 10 and FIG. 11 are diagrams illustrating a manufacturing method of a touch panel 400 according to a fourth embodiment of the present invention. As shown in figures, a first conductive layer L1 is first formed on a substrate 410. After performing lithography and etching steps on the first conductive layer L1, a lower layer portion of the first sensing units 420 arranged along the first direction A, a lower layer portion of the second sensing units 430 arranged along the second direction B, a first bridge unit 440 and first connection units 470 are formed. The first bridge unit 440 is wider than the first connection unit 470. Thereafter, insulation units 450 are formed above the first connection units 470 (for example, an insulation layer can be deposited on the first conductive layer, and then etched to form the insulation units 450). After forming the insulation units 450, a second conductive layer L2 is formed to cover all elements. other lithography and etching steps are then performed on the second conductive layer L2 for forming an upper layer portion of the first sensing units 420, an upper layer portion of the second sensing units 430, and a second bridge unit 460.

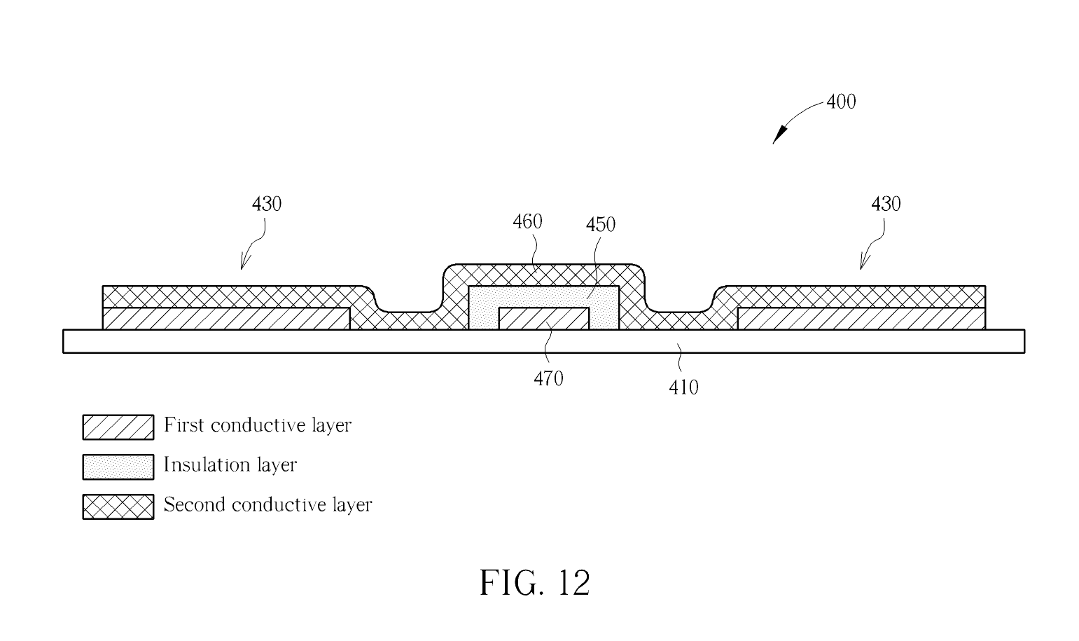

Please refer to FIG. 12, and refer to FIG. 10 and FIG. 11 as well. FIG. 12 is a cross-sectional view of the touch panel 400 according to the fourth embodiment of the present invention. As shown in figures, the first connection units 470 are for electrically connecting the first sensing units 420 and the first bridge unit 440, so as to electrically connect the two adjacent first sensing units 420. The second bridge unit 460 is for electrically connecting two adjacent second sensing units 430, and the second bridge unit 460 is arranged across over the first connection unit 470. The insulation units 450 are respectively arranged between the corresponding first connection units 470 and the second bridge units 460 for insulating the first connection units 470 and the second bridge units 460. The first connection units 470 and the first bridge unit 440 are formed from the first conductive layer. The second bridge units 460 are formed from the second conductive layer.

According to the above embodiment, the first sensing units 420 and the second sensing units 430 are formed from two conductive layers, that is, cross-sectional areas of the first sensing units 420 and the second sensing units 430 are increased, such that resistance of the first sensing units 420 and the second sensing units 430 can be reduced. In addition, the second conductive layer can be left on some part of the first bridge unit 440, in order to reduce resistance of the first bridge unit 440. The first bridge unit 440 is wider than the first connection unit 470, so as to reduce overall resistance of two connected adjacent first sensing unit 420.

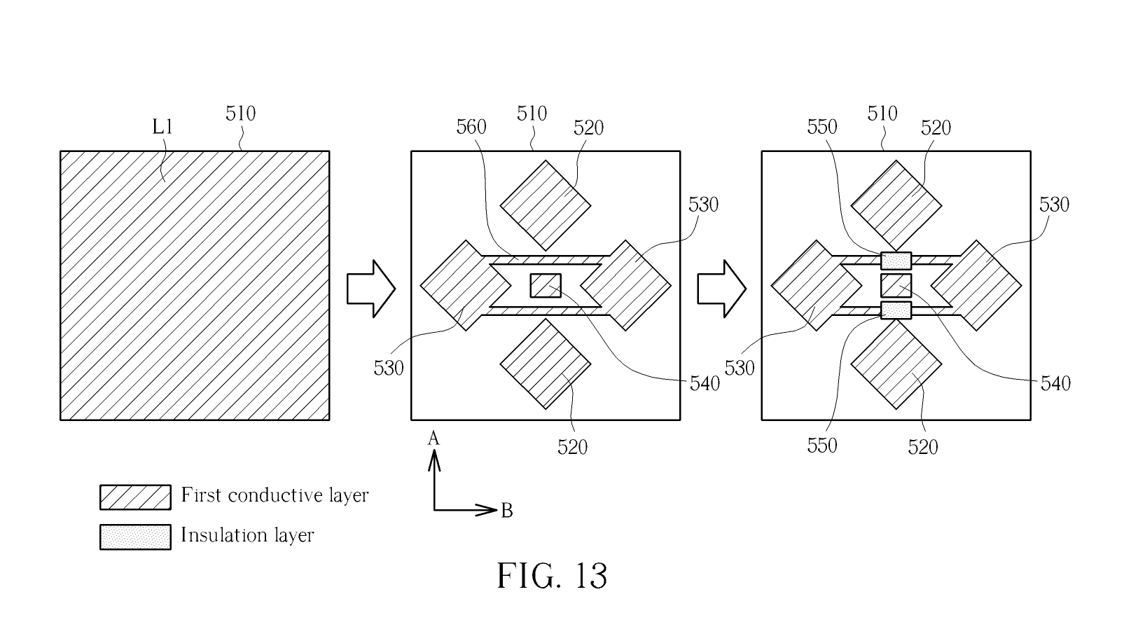

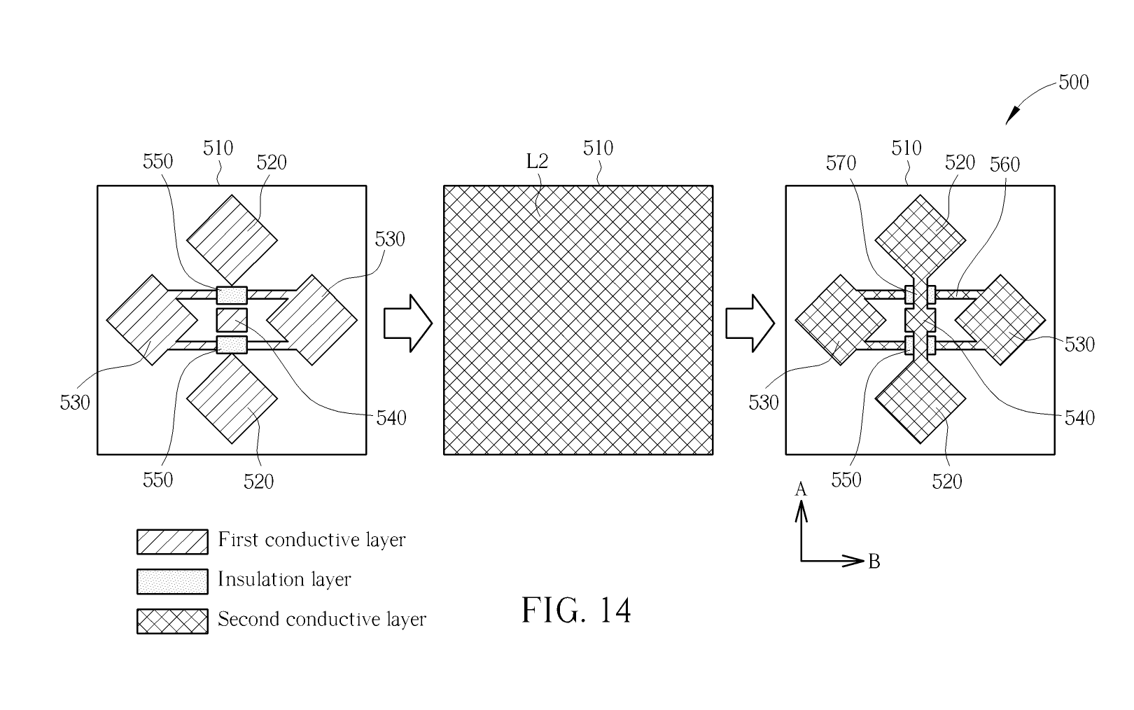

Please refer to FIG. 13 and FIG. 14 together. FIG. 13 and FIG. 14 are diagrams illustrating a manufacturing method of a touch panel 500 according to a fifth embodiment of the present invention. As shown in figures, a first conductive layer L1 is first formed on a substrate 510. After performing lithography and etching steps on the first conductive layer L1, a lower layer portion of the first sensing units 520 arranged along the first direction A, a lower layer portion of the second sensing units 530 arranged along the second direction B, a first bridge unit 540 and second bridge units 560 are formed. Thereafter, insulation units 550 are formed above the second bridge units 560 (for example, an insulation layer can be deposited on the first conductive layer, and then etched to form the insulation units 550). After forming the insulation units 550, a second conductive layer L2 is formed to cover all elements. other lithography and etching steps are then performed on the second conductive layer L2 for forming an upper layer portion of the first sensing units 520, an upper layer portion of the second sensing units 530, and a first connection unit 570.

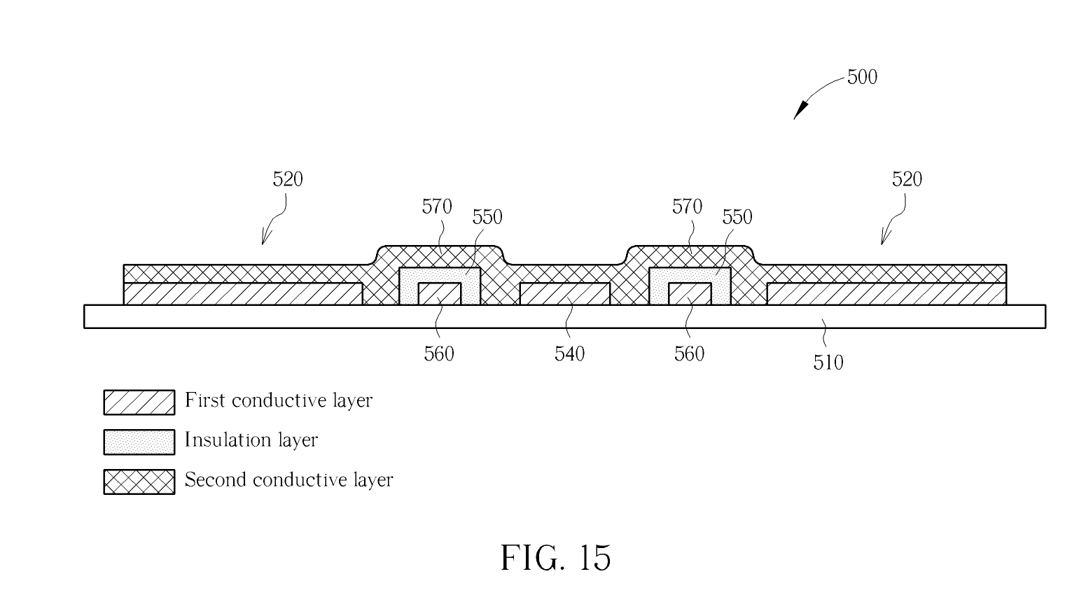

Please refer to FIG. 15, and refer to FIG. 13 and FIG. 14 as well. FIG. 15 is a cross-sectional view of the touch panel 500 according to the fifth embodiment of the present invention. As shown in figures, the first connection units 570 are for electrically connecting the first sensing units 520 and the first bridge unit 540, so as to electrically connect the two adjacent first sensing units 520. The first connection units 570 are arranged across over the second bridge units 560. The second bridge unit 560 is for electrically connecting two adjacent second sensing units 530. The insulation units 550 are respectively arranged between the corresponding first connection units 570 and the second bridge units 560 for insulating the first connection units 570 and the second bridge units 560. The first bridge unit 540 and the second bridge units 560 are formed from the first conductive layer. The first connection units 570 are formed from the second conductive layer.

According to the above embodiment, the first sensing units 520 and the second sensing units 530 are formed from two conductive layers, that is, cross-sectional areas of the first sensing units 520 and the second sensing units 530 are increased, such that resistance of the first sensing units 520 and the second sensing units 530 can be reduced. In addition, the second conductive layer can be left on some parts of the first bridge unit 540 and the second bridge units 560, in order to reduce resistance. The second conductive layer also can be removed from upper surfaces of the first bridge unit 540 and the second bridge units 560.

In the above embodiments, the first conductive layer and the second conductive layer can be transparent conductive layers, such as transparent conductive layers made of indium tin oxide (ITO). Resistance of the first conductive layer can be lower than resistance of the second conductive layer. The first conductive layer can be thicker than the second conductive layer. For example, material of the first conductive layer and the second conductive layer can be other type of known transparent conductive material. In addition, in the above embodiment, one of the first conductive layer and the second conductive layer can be a metal conductive layer (such as a metal grid layer or a metal film layer), and the other one of the first conductive layer and the second conductive layer can be a transparent conductive layer.

In contrast to the prior art, the touch panel of the present invention has a double conductive layer structure for reducing resistance of the first sensing units and the second sensing units. Therefore, the touch panel of the present invention can have shorter response time and better signal integrality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a plurality of first sensing units, arranged on the substrate along a first direction;
a plurality of second sensing units, arranged on the substrate along a second direction different from the first direction;
a plurality of first bridge units, for electrically connecting two adjacent first sensing units;
a plurality of second bridge units, arranged across over the plurality of first bridge units for electrically connecting two adjacent second sensing units; and
a plurality of insulation units, respectively arranged between the corresponding first bridge units and the second bridge units;
wherein the plurality of first sensing units and the plurality of second sensing units are formed by performing same lithography and etching steps on a first conductive layer and a second conductive layer after the second conductive layer forming on the first conductive layer.

2. The touch panel of claim 1, wherein the first bridge units are formed from the first conductive layer, and the second bridge units are formed from the second conductive layer.

3. The touch panel of claim 1, wherein the plurality of first sensing units and the plurality of second sensing units have a same outline.

4. The touch panel of claim 3, wherein the outline of the plurality of first sensing units and the plurality of second sensing units has a plurality of concave parts and convex parts.

5. The touch panel of claim 1, wherein the resistance of the first conductive layer is lower than the resistance of the second conductive layer.

6. The touch panel of claim 1, wherein the first conductive layer is thicker than the second conductive layer.

7. A touch panel, comprising:
a substrate;
a plurality of first sensing units, arranged on the substrate along a first direction;
a plurality of second sensing units, arranged on the substrate along a second direction different from the first direction;
a plurality of first bridge units, for electrically connecting two adjacent first sensing units;
a plurality of second bridge units, arranged across over the corresponding first sensing units for electrically connecting two adjacent second sensing units; and
a plurality of insulation units, respectively arranged between the corresponding first sensing units and the second bridge units;
wherein the plurality of first sensing units and the plurality of second sensing units are formed from a first conductive layer and a second conductive layer disposed on the first conductive layer.

8. The touch panel of claim 7, wherein each of the first sensing units comprises an extension part, and each of the second bridge units is arranged across over the extension part of the corresponding first sensing unit.

9. The touch panel of claim 7, wherein the first bridge units are formed from the first conductive layer, and the second bridge units are formed from the second conductive layer.

10. The touch panel of claim 7, wherein one of the first conductive layer and the second conductive layer is a metal conductive layer, and the other one of the first conductive layer and the second conductive layer is a transparent conductive layer.

11. The touch panel of claim 10, wherein the metal conductive layer is a metal grid layer.

12. The touch panel of claim 7, wherein the resistance of the first conductive layer is lower than the resistance of the second conductive layer.

13. The touch panel of claim 7, wherein the first conductive layer is thicker than the second conductive layer.

14. A touch panel, comprising:
a substrate;
a plurality of first sensing units, arranged on the substrate along a first direction;
a plurality of second sensing units, arranged on the substrate along a second direction different from the first direction;
a plurality of first bridge units, arranged between two adjacent first sensing units;
a plurality of second bridge units, arranged across over the plurality of first bridge units for electrically connecting two adjacent second sensing units;
a plurality of first connection units, for electrically connecting the first sensing units and the first bridge units; and
a plurality of insulation units, respectively arranged between the corresponding first bridge units and the second bridge units;
wherein the plurality of first sensing units and the plurality of second sensing units are formed from two conductive layers.

15. The touch panel of claim 14, wherein the plurality of first sensing units and the plurality of second sensing units are formed from a metal grid layer and a transparent conductive layer disposed on the metal grid layer, the plurality of first bridge units are formed from the metal grid layer, and the plurality of second bridge units and the plurality of first connection units are formed from the transparent conductive layer.

16. The touch panel of claim 14, wherein the plurality of first sensing units and the plurality of second sensing units are formed from a first conductive layer and a second conductive layer disposed on the first conductive layer, the plurality of first connection units and the plurality of first bridge units are formed from the first conductive layer, and the plurality of second bridge units are formed from the second conductive layer.
